(19) United States
(12) Patent Application Publication
(10) Pub. No.: US 2023/0103825 A1
(43) Pub. Date: Apr. 6, 2023

(54) ELECTRODE FOR LITHIUM-ION SECONDARY BATTERY, AND LITHIUM-ION SECONDARY BATTERY

(71) Applicant: HONDA MOTOR CO., LTD., Tokyo (JP)

(72) Inventors: Ken BABA, Saitama (JP); Kazuaki MATSUMOTO, Saitama (JP)

(21) Appl. No.: 17/802,971

(22) PCT Filed: Mar. 10, 2020
(86) PCT No.: PCT/JP2020/010196

§ 371 Date: Aug. 29, 2022

(51) Int. Cl. H01M 4/62; H01M 10/0525; H01M 4/13; H01M 10/0562; H01M 10/0566

(52) U.S. Cl. CPC H01M 4/62; H01M 10/0525; H01M 4/13; H01M 10/0562; H01M 10/0566; H01M 2004/021

(57) ABSTRACT

The purpose of the present invention is to provide an electrode for a lithium-ion secondary battery that is capable of satisfying both heat stability and durability, and a lithium-ion secondary battery that uses the positive electrode. According to the present invention, a specific electrolyte and highly-dielectric solid particles are present in an electrode mixture layer. Specifically, the electrode for a lithium-ion battery is configured such that the electrode mixture layer includes an electrode active material, a highly-dielectric solid oxide, and an electrolyte, wherein the electrolyte has an average molecular weight of a solvent of at least 110, a flash point of at least 21° C., and a viscosity of at least 3.0 MPa·s.

### TECHNICAL FIELD

The present invention relates to a lithium ion secondary battery electrode and a lithium ion secondary battery including such an electrode.

### BACKGROUND ART

Conventionally, as secondary batteries having a high energy density, lithium ion secondary batteries are widely used. A lithium ion secondary battery including a liquid as an electrolyte has a structure in which a separator is provided between a positive electrode and a negative electrode and the lithium ion secondary battery is filled with the liquid electrolyte (electrolytic solution).

Since the lithium ion secondary battery as described above includes an organic solvent as the liquid electrolytic solution, the lithium ion secondary battery generally has poor thermal stability. In order to cope with this problem, a technique is proposed in which a small amount of fluorine-based solvent having a flash point of 150° C. or more is added to an electrolytic solution, and thus rupture and ignition of a battery caused by nail puncture is suppressed without the resistance of the battery being increased (see Patent Document 1).

However, when the amount of fluorine-based solvent added is increased in order to enhance thermal stability, deterioration of durability is caused, with the result that both safety and durability were not fully satisfied.
Patent Document 1: Japanese Unexamined Patent Application, Publication No. 2001-060464

### DISCLOSURE OF THE INVENTION

### Problems to be Solved by the Invention

The present invention is made in view of the background art described above, and the object of the present invention is to provide a lithium ion secondary battery electrode which can satisfy both thermal stability and durability and to provide a lithium ion secondary battery which includes the positive electrode.

### Means for Solving the Problems

The present inventors have conducted a thorough study to find that a specific electrolytic solution and high dielectric solid particles are provided in an electrode material mixture layer to be able to solve the problem described above, with the result that the present invention has been completed.

Specifically, the present invention provides a lithium ion secondary battery electrode including an electrode material mixture layer which includes: an electrode active material; a high dielectric oxide solid; and an electrolytic solution, and in the electrolytic solution, a solvent has an average molecular weight of 110 or more, a flash point of 21° C. or more and a viscosity of 3.0 mPa·s or more.

The high dielectric oxide solid and the electrolytic solution may be disposed in gaps of the electrode active material.

In a cross-sectional observation of the lithium ion secondary battery electrode, a ratio of the cross-sectional area of the high dielectric oxide solid to the cross-sectional area of the total gaps may be 1 to 22%.

The high dielectric oxide solid may be an oxide solid electrolyte.

The oxide solid electrolyte may be at least one type selected from the group consisting of Li₇La₃Zr₂O₁₂(LLZO), Li_{6.75}La₃Zr_{1.75}Ta_{0.25}O₁₂ (LLZTO), Li_{0.33}La_{0.56}TiO₃ (LLTO), Li_{1.3}Al_{0.3}Ti_{1.7}(PO₄)₃(LATP) and Li_{1.6}Al_{0.6}Ge_{1.4}(PO₄)₃(LAGP).

The volume filling rate of the electrode active material with respect to the volume of the entire electrode material mixture layer may be 60% or more.

The thickness of the electrode material mixture layer may be 40 μm or more.

The lithium ion secondary battery electrode may be a positive electrode.

The lithium ion secondary battery electrode may be a negative electrode.

Another aspect of the present invention provides a lithium ion secondary battery including: the lithium ion secondary battery electrode described above; and an electrolytic solution.

### Effects of the Invention

With the lithium ion secondary battery electrode of the present invention, it is possible to realize a lithium ion secondary battery which satisfies both thermal stability and durability.

### BRIEF DESCRIPTION OF THE DRAWINGS

FIG. 1 is a diagram showing an embodiment of the lithium ion secondary battery of the present invention.

### PREFERRED MODE FOR CARRYING OUT THE INVENTION

An embodiment of the present invention will be described below. The present invention is not limited to the following embodiment.

### <Lithium Ion Secondary Battery Electrode>

The lithium ion secondary battery electrode of the present invention includes an electrode material mixture layer which includes an electrode active material, a high dielectric oxide solid and an electrolytic solution, and in the electrolytic solution included in the electrode material mixture layer, a solvent has an average molecular weight of 110 or more, a flash point of 21° C. or more and a viscosity of 3.0 mPa·s or more.

The lithium ion secondary battery electrode of the present invention may be a lithium ion secondary battery positive electrode or a lithium ion secondary battery negative electrode.

Although the configuration of the lithium ion secondary battery electrode of the present invention is not particularly limited, examples thereof include a configuration in which the electrode material mixture layer formed of an electrode material mixture including the electrode active material and the high dielectric oxide solid is stacked on an electrode current collector, and the electrode material mixture layer is impregnated with the electrolytic solution.

### [Current Collector]

The electrode current collector in the lithium ion secondary battery electrode of the present invention is not particularly limited, and a known current collector used in a lithium ion secondary battery can be used.

Examples of the material of a positive electrode current collector can include metal materials such as SUS, Ni, Cr, Au, Pt, Al, Fe, Ti, Zn and Cu and the like. Examples of the material of a negative electrode current collector can include SUS, Ni, Cu, Ti, Al, calcined carbon, a conductive polymer, conductive glass, an Al—Cd alloy and the like.

Examples of the shape of the electrode current collector can include a foil shape, a plate shape, a mesh shape and the like. The thickness thereof is not particularly limited, and though examples of the thickness can include 1 to 20 μm, the thickness can be selected as necessary.

### [Electrode Material Mixture Layer]

In the lithium ion secondary battery electrode of the present invention, the electrode material mixture layer includes the electrode active material and the high dielectric oxide solid as essential components. The electrode material mixture layer is preferably formed on at least one surface of the current collector, and may be formed on both surfaces. The electrode mixture layer can be selected as necessary according to the type and structure of the target lithium ion secondary battery.

As long as the electrode material mixture layer includes, as essential components, the electrode active material and the high dielectric oxide solid which are constituent elements of the present invention, any other components may be included. Examples of the arbitrary components can include known components such as a conductive aid and a binder.

### (Thickness of Electrode Material Mixture Layer)

Although the thickness of the electrode material mixture layer in the lithium ion secondary battery electrode of the present invention is not particularly limited, for example, the thickness is preferably 40 μm or more. When the thickness is 40 μm or more, and the volume filling rate of the electrode active material is 60% or more, the lithium ion secondary battery electrode which is obtained is a high-density electrode. Then, the volumetric energy density of a battery cell which is produced can reach 500 Wh/L or more.

### [Electrolytic Solution]

In the electrolytic solution disposed in the gaps of the particles of the electrode active material in the lithium ion secondary battery electrode of the present invention, the average molecular weight, the flash point and the viscosity of the solvent satisfy specific conditions.

The electrolytic solution used when the lithium ion secondary battery electrode of the present invention is used to form the secondary battery may be the same as or different from the electrolytic solution disposed in the lithium ion secondary battery electrode of the present invention.

### (Solvent)

### (Average Molecular Weight)

The average molecular weight of the solvent of the electrolytic solution included in the electrode material mixture layer of the lithium ion secondary battery electrode of the present invention is 110 or more. The average molecular weight is preferably 115 or more, and more preferably 120 or more.

When the average molecular weight of the solvent of the electrolytic solution included in the electrode material mixture layer is 110 or more, since the flash point is 21° C. or more, ignition is unlikely to occur when an abnormality occurs.

Examples of a method of performing preparation such that the average molecular weight falls in the range described above can include a method of mixing a necessary amount of compound having a large molecular weight such as a carbonate solvent.

### (Flash Point)

The flash point of the solvent of the electrolytic solution included in the electrode material mixture layer of the lithium ion secondary battery electrode of the present invention is 21° C. or more. The flash point is further preferably 25° C. or more.

When the flash point of the solvent of the electrolytic solution included in the electrode material mixture layer is 21° C. or more, it is possible to produce a lithium ion secondary battery which is excellent in stability in a high temperature environment.

Examples of a method of performing preparation such that the flash point falls in the range described above can include a method of mixing a high flash point solvent, and examples of the high flash point solvent can include tert-butylphenylcarbonate and the like.

### (Viscosity)

The viscosity of the solvent of the electrolytic solution included in the electrode material mixture layer of the lithium ion secondary battery electrode of the present invention is 3.0 mPa·s or more. The viscosity is more preferably 3.5 mPa·s, and further preferably 4.0 mPa·s or more.

In general, when the viscosity of the solvent of the electrolytic solution included in the electrode material mixture layer is so high as to be 3.0 mPa·s or more, lithium ions are unlikely to diffuse, with the result that the ion conductivity is lowered. However, since in the lithium ion secondary battery electrode of the present invention, not only the electrolytic solution but also the high dielectric oxide solid is provided in the gaps formed between the particles of the electrode active material, the ion conductivity is considered to have been enhanced. In this way, the electrode excellent in thermal stability can be obtained, and thus it is possible to ensure the safety of the lithium ion secondary battery.

Examples of a method of performing preparation such that the viscosity falls in the range described above can include a method of approximately mixing a solvent having a high viscosity such as EC or PC and a solvent having a low viscosity such as DMC or EMC.

### (Type)

As the solvent of the electrolytic solution included in the electrode material mixture layer of the lithium ion secondary battery electrode of the present invention, a general solvent which forms a non-aqueous electrolytic solution can be used. Examples thereof can include cyclic carbonates having a cyclic structure such as ethylene carbonate (EC) and propylene carbonate (PC) and chain carbonates such as dimethyl carbonate (DMC), ethylmethyl carbonate (EMC) and diethyl carbonate (DEC).

Carbonates having a large molecular weight such as benzyl phenyl carbonate, bis(pentafluorophenyl) carbonate, bis(2-methoxyphenyl) carbonate, bis(pentafluorophenyl) carbonate and tert-butyl phenyl carbonate can also be used.

Furthermore, fluoroethylene carbonate (FEC), difluoroethylene carbonate (DFEC) and the like which are partially fluorinated can be used.

A known additive can be mixed with the electrolytic solution, and examples of the additive can include vinylene carbonate (VC), vinyl ethylene carbonate (VEC), propane sulton (PS), fluoroethylene carbonate (FEC) and the like.

The electrolytic solution may include an ion liquid. Examples of the ion liquid can include pyrrolidinium, piperidinium, imidazolium and the like which include quadruple ammonium cations.

In general, in a case where an electrolytic solution includes a large amount of low boiling point solvent such as chain carbonate, when a battery is overcharged, a large amount of heat is generated. Hence, in order to ensure sufficient safety, a protection circuit for overcharge prevention is provided or a plurality of protection mechanisms such as a safety valve and a current shutoff valve are provided, with the result that a step of manufacturing the battery is complicated and the energy density of the battery is lowered.

On the other hand, in a case where an electrolytic solution includes a large amount of high boiling point solvent such as cyclic carbonate or long chain carbonate, although safety is ensured, uneven distribution of the electrolytic solution occurs during charge/discharge cycles, with the result that the durability of the battery is lowered.

In the composition of the electrolytic solution included in the electrode material mixture layer of the lithium ion secondary battery electrode of the present invention, as the solvent, the ratio of cyclic carbonate is increased, and the ratio of carbonate having a large molecular weight is simultaneously increased. In the present invention, the electrolytic solution as described above and the high dielectric oxide solid included in the electrode material mixture layer are provided together, and thus uneven distribution of the electrolytic solution is prevented and the ion conductivity is enhanced, with the result that the safety of the battery can be enhanced without durability being adversely affected.

In the electrolytic solution included in the lithium ion secondary battery electrode of the present invention, the ratio of cyclic carbonate is preferably 15% by volume or more and 50% by volume or less. The ratio of cyclic carbonate is more preferably 20% by volume or more and 45% by volume or less, and particularly preferably 25% by volume or more and 40% by volume or less.

In the electrolytic solution included in the lithium ion secondary battery electrode of the present invention, the ratio of carbonate having a large molecular weight is preferably 0.01% by volume or more and 50% by volume or less. The ratio of carbonate having a large molecular weight is more preferably 0.05% by volume or more and 40% by volume or less, and particularly preferably 0.1% by volume or more and 30% by volume or less.

In the electrolytic solution included in the lithium ion secondary battery electrode of the present invention, the ratio of chain carbonate is preferably 1% by volume or more and 80% by volume or less. The ratio of chain carbonate is more preferably 10% by volume or more and 75% by volume or less, and particularly preferably 20% by volume or more and 70% by volume or less.

### (Lithium Salt)

Although in the lithium ion secondary battery electrode of the present invention, a lithium salt included in the electrolytic solution disposed in the gaps of the particles of the electrode active material is not particularly limited, examples thereof can include LiPF₆, LiBF₄, LiClO₄, LiN(SO₂CF₃), LiN(SO₂C₂F₅)₂, LiCF₃SO₃, and the like. Among them, LiPF₆ and LiBF₄ having high ion conductivity and also a high degree of dissociation or a mixture thereof is preferable.

The concentration of the lithium salt included in the electrolytic solution disposed in the gaps of the particles of the electrode active material falls in a range of 0.5 to 3.0 mol/L. When the concentration of the lithium salt is less than 0.5 mol/L, the ion conductivity is lowered whereas when the concentration of the lithium salt exceeds 3.0 mol/L, the viscosity is high and the ion conductivity is low, and thus it is difficult to sufficiently obtain the effect of the solid oxide.

In the present invention, the concentration of the lithium salt included in the electrolytic solution disposed in the gaps of the particles of the electrode active material preferably falls in a range of 1.0 to 3.0 mol/L, and most preferably falls in a range of 1.2 to 2.2 mol/L in order to increase output performance after durability.

In general, when the concentration of a lithium salt in an electrolytic solution is high, since the viscosity of the electrolytic solution is increased, the permeability of the electrolytic solution to an electrode is lowered. However, in the lithium ion secondary battery electrode of the present invention, not only the electrolytic solution but also the high dielectric oxide solid is provided in the gaps formed between the particles of the electrode active material, with the result that the permeability of the electrolytic solution is enhanced.

In general, when the concentration of the lithium salt in the electrolytic solution is high, since association of lithium ions with anions occurs, the ion conductivity tends to be lowered. However, in the lithium ion secondary battery electrode of the present invention, not only the electrolytic solution but also the high dielectric oxide solid is provided in the gaps formed between the particles of the electrode active material, with the result that the ion conductivity is considered to have been enhanced.

Hence, as the electrolytic solution disposed in the gaps of the particles of the electrode active material in the lithium ion secondary battery electrode of the present invention, an electrolytic solution which has a higher concentration than the concentration of the lithium salt in the electrolytic solution applied to the normal lithium ion secondary battery can be applied. Even when the electrolytic solution having a higher concentration is applied, since the impregnation time of the electrolytic solution into the electrode is short, the productivity can be enhanced, and it is possible to obtain the battery having a high initial capacity.

[Electrode Active Material]

The electrode active material included in the lithium ion secondary battery electrode of the present invention is not particularly limited as long as the electrode active material can store and release lithium ions, and a known material serving as an electrode active material for a lithium ion secondary battery can be applied.

### (Positive Electrode Active Material)

When the lithium ion secondary battery electrode of the present invention is a lithium ion secondary battery positive electrode, a positive electrode active material layer is not particularly limited, and examples thereof can include LiCoO₂, LiCOO₄, LiMn₂O₄, LiNiO₂, LiFePO₄, lithium sulfide, sulfur and the like. As the positive electrode active material, a positive electrode active material which shows a noble potential as compared with the negative electrode is preferably selected from materials capable of forming an electrode.

### (Negative Electrode Active Material)

When the lithium ion secondary battery electrode of the present invention is a lithium ion secondary battery negative electrode, examples of the negative electrode active material can include metallic lithium, a lithium alloy, metal oxide, metal sulfide, metal nitride, silicon oxide, silicon, carbon materials such as graphite and the like. As the negative electrode active material, a negative electrode active material which shows a low potential as compared with the positive electrode is preferably selected from materials capable of constituting an electrode.

### (Volume Filling Rate of Electrode Active Material)

In the lithium ion secondary battery electrode of the present invention, the volume filling rate of the electrode active material with respect to the volume of the entire electrode material mixture layer is preferably 60% or more. When the volume filling rate of the electrode active material is 60% or more, the ratio of the gaps formed between the particles of the electrode active material with respect to the volume of the entire electrode material mixture layer is less than 40%. Hence, the lithium ion secondary battery electrode having a low gap ratio is formed, and thus the electrode having a high volumetric energy density can be formed. When the volume filling rate of the electrode active material is 60% or more, a cell can realize, for example, a high volumetric energy density of 500 Wh/L or more.

The volume filling rate of the electrode active material with respect to the volume of the entire electrode material mixture of the electrode is further preferably 65% or more, and most preferably 70% or more.

### [High Dielectric Oxide Solid]

The high dielectric oxide solid included in the lithium ion secondary battery electrode of the present invention is not particularly limited as long as the high dielectric oxide solid is an oxide with a high permittivity. In general, the permittivity of solid particles crushed from a crystalline state is changed from the original crystalline state, and thus the permittivity is lowered. Hence, as the high dielectric oxide solid used in the present invention, powder crushed in a state where a high dielectric state can be maintained as much as possible is preferably used.

### (Powder Relative Permittivity)

The powder relative permittivity of the high dielectric oxide solid used in the present invention is preferably 10 or more, and further preferably 20 or more. When the powder relative permittivity is 10 or more, even if the charge/discharge cycle is repeated, an increase in internal resistance can be reduced, with the result that it is possible to fully realize a lithium ion secondary battery having excellent durability for the charge/discharge cycle.

Here, the “powder relative permittivity” in the present specification refers to a value which is determined as follows.

### (Method of Measuring Powder Relative Permittivity)

Powder is introduced into a 38 mm diameter (R) tablet molding machine for measurement, and is compressed using a hydraulic press such that the thickness (d) is 1 to 2 mm, with the result that compacted powder is formed. The molding conditions of the compacted powder are set such that the relative density of the powder (D_{powder})=compacted powder weight density/true specific gravity of the dielectric×100 is 40% or more, the capacitance Cₜₒₜₐₗ of the molded product is measured at 1 kHz at 25° C. by an automatic balancing bridge method using an LCR meter and thus a compacted powder relative permittivity εₜₒₜₐₗ is calculated. In order to determine the permittivity ε_{podwer} of an actual volume portion from the compacted powder relative permittivity obtained, on assumption that the vacuum permittivity ε₀ is 8.354×10−12 and the permittivity of air εₐᵢᵣ is 1, the following formulae (1) to (3) are used to calculate the “powder relative permittivity ε_{powder}”.

Contact area A between compacted powder and electrode=(R/2)²*π (1)

Cₜₒₜₐₗ=εₜₒₜₐₗ×ε₀×(A/d) (2)

εₜₒₜₐₗ=ε_{powder}×D_{powder}+εₐᵢᵣ×(1−D_{powder}) (3)

### (Particle Diameter)

Although the particle diameter of the high dielectric oxide solid is not particularly limited, the particle diameter is preferably approximately equal to or more than 0.1 μm and equal to or less than 10 μm which is the particle size of the active material. When the particle diameter of the high dielectric oxide solid is excessively large, the filling rate of the active material in the electrode is prevented from being increased.

### (Disposition of High Dielectric Oxide Solid)

In the electrode material mixture layer of the lithium ion secondary battery electrode of the present invention, the high dielectric oxide solid is preferably disposed in the gaps of the electrode active material. The gaps formed between the particles of the electrode active material can be controlled by the filling rate of the electrode active material, and are related to the density of the electrode material mixture layer. In the gaps of the particles of the electrode active material, a resin binder serving as a binder, a carbon material serving as a conductive aid for providing electronic conductivity and the like may be disposed.

In the gaps of the particles of the electrode active material, the high dielectric oxide solid is disposed, and thus the lithium ion secondary battery electrode of the present invention can reduce a decrease in the diffusion of lithium ions within the electrode to reduce an increase in resistance, with the result that it is possible to realize the electrode having a high filling density of the electrode active material. Consequently, even when the volumetric energy density is high and the electrode holds a small amount of electrolytic solution, it is possible to realize the lithium ion secondary battery which reduces a decrease in output caused by the repetition of the charge and discharge.

In the gaps of the particles of the electrode active material, the high dielectric oxide solid is disposed, and thus in the lithium ion secondary battery electrode of the present invention, the permeability of the electrolytic solution is enhanced. Consequently, uniformity of the electrolytic solution held in the electrode is enhanced. Hence, it is possible to uniformly form an SET film in the negative electrode and to suppress electrodeposition of lithium. It is further possible to reduce the impregnation time of the electrolytic solution into the electrode and to enhance the productivity.

Furthermore, in the gaps of the particles of the electrode active material, the high dielectric oxide solid is disposed, and thus in the lithium ion secondary battery electrode of the present invention, by the dielectric effect, it is possible to suppress association of lithium ions with anions. Consequently, for example, even when the electrolytic solution containing a high concentration of lithium salt is used, it is possible to achieve the effect of reducing the resistance.

The high dielectric oxide solid is disposed in an electrode material mixture paste for forming the electrode material mixture layer, and thus in the electrode material mixture layer which is formed, the high dielectric oxide solid can be easily disposed between the particles of the electrode active material, and it is easy to substantially uniformly arrange the high dielectric oxide solid over the entire electrode material mixture layer. Furthermore, when the high dielectric oxide solid is previously adhered to a conductive aid, a binder and the like, and is thereafter mixed with the electrode active material to produce the electrode material mixture paste, the dielectric solid powder can be more uniformly disposed in the gaps of the particles of the electrode active material.

### (Cross-Sectional Area Occupancy Rate of High Dielectric Oxide Solid in Gap Portion)

With respect to the occupancy rate of the high dielectric oxide solid in the gaps of the particles of the electrode active material in the lithium ion secondary battery electrode of the present invention, in a cross-sectional observation of the lithium ion secondary battery electrode, the ratio of the cross-sectional area of the high dielectric oxide solid to the cross-sectional area of the total gaps is preferably in a range of 1 to 22%. The ratio is in the range described above, and thus it is possible to obtain both the effect of reducing the resistance and the effect of enhancing durability.

Here, the gaps in the present invention mean, as described above, an area other than a region occupied by the active material in the electrode material mixture layer, and in the gaps, a resin binder serving as a binder, a carbon material for providing electronic conductivity and the like may be disposed. In order to determine the occupancy rate of the high dielectric oxide solid in a gap portion, the cross-sectional observation of the lithium ion secondary battery electrode is performed. The cross-sectional observation is performed by the following procedure.

### (Method for Cross-Sectional Observation)

A cross section of the electrode material mixture layer is produced by an ion milling method to be observed by SEM.
As the shooting range of a cross-sectional SEM, a range of about 80% or more in the direction of thickness of the electrode of the electrode material mixture layer (up/down direction) is selected.
A shooting magnification is set to about 5000 to 10000 times, and an image is divided and shot as a plurality of images.
As in the up/down direction, an image in a planar direction (left/right direction) is shot.
The images obtained are combined together, binarization processing is performed on the brightness of a reflected electron image and thus an area occupancy rate of each of the components of the electrode material mixture is derived from a brightness distribution curve.
For the area occupancy rate, an active material region and an oxide solid region are set, and a dark portion other than the regions described above is defined as the remaining space. In the remaining space, a resin binder, a conductive aid and the like are present, and holes which are impregnated with the electrolytic solution are also included.

The reason why the cross-sectional area occupancy rate of the high dielectric oxide solid in the gap portion is preferably in the range of 1 to 22% is due to the permittivity of the high dielectric oxide solid itself. Specifically, when the permittivity of the high dielectric oxide solid is increased, an influence exerted on the electrolytic solution is increased, and thus the preferable cross-sectional area occupancy rate of the high dielectric oxide solid approaches 1%. By contrast, when the permittivity of the high dielectric oxide solid is decreased, the preferable cross-sectional area occupancy rate of the high dielectric oxide solid approaches 22%.

When the cross-sectional area occupancy rate of the high dielectric oxide solid is less than 1%, the dielectric action of the high dielectric oxide solid is reduced, and thus the same action as in a normal electrolytic solution is only obtained. On the other hand, when the cross-sectional area occupancy rate of the high dielectric oxide solid exceeds 22%, in the gap portion, the electrolytic solution is relatively reduced to run out, and thus a lithium ion movement path is reduced, with the result that the internal resistance is increased.

### (Type of High Dielectric Oxide Solid)

Although the high dielectric oxide solid is not particularly limited as long as the high dielectric oxide solid is an oxide with a high permittivity, the high dielectric oxide solid is preferably an oxide solid electrolyte. When the high dielectric oxide solid is the oxide solid electrolyte, an inexpensive crystal can be produced, and the high dielectric oxide solid is excellent in electrochemical oxidation resistance and reduction resistance. Since the true specific gravity of the oxide solid electrolyte is low, it is possible to reduce an increase in the weight of the electrode.

Furthermore, the high dielectric oxide solid is preferably an oxide solid electrolyte which has lithium ion conductivity. When the high dielectric oxide solid is a high dielectric oxide solid electrolyte having lithium ion conductivity, the output of the obtained lithium ion secondary battery at low temperature can be more enhanced. It is also possible to relatively inexpensively produce the lithium ion secondary battery electrode which is excellent in electrochemical oxidation resistance and reduction resistance.

Examples of the high dielectric oxide solid can include: a composite metal oxide having a perovskite crystal structure such as BaTiO₃, BaₓSr₁₋ₓTiO₃ (X=0.4 to 0.8), BaZrₓTi_{1-z}O₃ (X=0.2 to 0.5) or KNbO₃; and a composite metal oxide having a layered perovskite crystal structure containing bismuth such as SrBi₂Ta₂O₉ or SrBi₂Nb₂O₉.

Furthermore, the high dielectric oxide solid preferably has lithium ion conductivity, and, for example, the high dielectric oxide solid is more preferably at least one type selected from the group consisting of Li₇La₃Zr₂O₁₂(LLZO), Li_{6.75}La₃Zr_{1.75}Ta_{0.25}O₁₂(LLZTO), Li_{0.33}La_{0.56}TiO₃(LLTO), Li_{1.3}Al_{0.3}Ti_{1.7}(PO₄)₃(LATP) and Li_{1.6}Al_{0.6}Ge_{1.4} (PO₄)₃(LAGP).

### (Amount of High Dielectric Oxide Solid Mixed)

The amount of high dielectric oxide solid mixed in the electrode material mixture layer with respect to the total mass of the electrode material mixture layer is preferably in a range of 0.1 to 5% by mass, further preferably in a range of 0.25 to 4% by mass and particularly preferably in a range of 0.5 to 3% by mass. The amount is in the range of 0.1 to 5% by mass, and thus it is possible to obtain both the effect of reducing the resistance and the effect of enhancing durability.

### <Method for Manufacturing Lithium Ion Secondary Battery Electrode>

A method for manufacturing the lithium ion secondary battery electrode of the present invention is not particularly limited, and a normal method in the present technical field can be applied. Examples thereof can include a method in which the electrode material mixture paste containing the electrode active material and the high dielectric oxide solid as essential components is applied on the electrode current collector, is dried and is then rolled, and the lithium ion secondary battery electrode is thereafter impregnated with the electrolytic solution. Here, a press pressure in the rolling is changed, and thus it is possible to control the volume filling rate of the electrode active material (that is, the ratio of the gaps formed between the particles of the electrode active material).

As a method of applying the electrode paste to the electrode current collector, a known method can be applied. Examples thereof can include methods such as roller coating using an applicator roll, screen coating, blade coating, spin coating and bar coating.

### <Liithium Ion Secondary Battery>

The lithium ion secondary battery of the present invention includes the lithium ion secondary battery electrode of the present invention and the electrolytic solution. In the lithium ion secondary battery of the present invention, the lithium ion secondary battery electrode of the present invention may be the positive electrode or the negative electrode or both the positive electrode and the negative electrode are the lithium ion secondary battery electrode of the present invention.

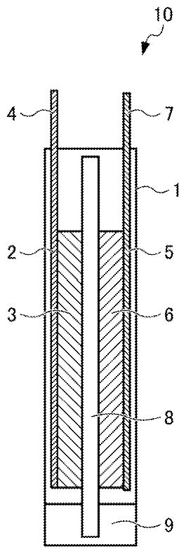

FIG. 1 shows an embodiment of the lithium ion secondary battery of the present invention. The lithium ion secondary battery 10 shown in FIG. 1 includes: a positive electrode 4 which has a positive electrode material mixture layer 3 formed on a positive electrode current collector 2; a negative electrode 7 which has a negative electrode material mixture layer 6 formed on a negative electrode current collector 5; a separator 8 which electrically insulates the positive electrode 4 and the negative electrode 7; an electrolytic solution 9; and a container 1 which houses the positive electrode 4, the negative electrode 7, the separator 8 and the electrolytic solution 9.

Within the container 1, the positive electrode material mixture layer 3 and the negative electrode material mixture layer 6 are opposite each other through the separator 8, and the electrolytic solution 9 is stored below the positive electrode material mixture layer 3 and the negative electrode mixture layer 6. An end portion of the separator 8 is immersed in the electrolytic solution 9. The positive electrode 4 or the negative electrode 7 or both of them are the lithium ion secondary battery electrode of the present invention, and include the electrode active material, the high dielectric oxide solid and the electrolytic solution, and the high dielectric oxide solid and the electrolytic solution are disposed in the gaps formed between the particles of the electrode active material.

### [Positive Electrode and Negative Electrode]

In the lithium ion secondary battery of the present invention, the positive electrode or the negative electrode or both the positive electrode and the negative electrode are the lithium ion secondary battery electrode of the present invention. When the lithium ion secondary battery electrode of the present invention is used only for the positive electrode, as the negative electrode, a metal, a carbon material or the like serving as the negative electrode active material can be used as a sheet without being processed.

### [Electrolytic Solution]

The electrolytic solution applied to the lithium ion secondary battery of the present invention is not particularly limited, and a known electrolytic solution can be used as the electrolytic solution for the lithium ion secondary battery. The electrolytic solution used when the lithium ion secondary battery is formed may be the same as or different from the electrolytic solution disposed in the lithium ion secondary battery electrode of the present invention.

### <Method for Manufacturing Lithium Ion Secondary Battery>

A method for manufacturing the lithium ion secondary battery of the present invention is not particularly limited, and a normal method in the present technical field can be applied.

### EXAMPLES

Although the present invention will then be described in more detail based on Examples and the like, the present invention is not limited to them.

### Example 1

### [Production of Positive Electrode]

Acetylene black serving as a conductive aid and Li_{1.3}Al_{0.3}Ti_{1.7}(PO₄)₃(LATP) serving as an oxide solid electrolyte were mixed, and were mixed and dispersed with a planetary centrifugal mixer, with the result that a mixture was obtained. Then, polyfluoride vinylidene (PVDF) serving as a binder and LiNi_{0.6}Co_{0.2}Mn_{0.2}O₂ (NCM622, D50=12 μm) serving as a positive electrode active material were added to the mixture obtained, and were dispersed with a planetary mixer, with the result that a mixture for positive electrode material mixture was obtained. The mixing was performed such that the mass ratio of the components of the mixture for positive electrode material mixture was positive electrode active material:LATA:conductive aid:resin binder (PCDF)=92.1:2:4.1:1.8, that is, the mixing was performed such that the amount of LATP added was 2 parts by mass with respect to 100 parts by mass of the mixture for positive electrode material mixture. Then, the mixture for positive electrode material mixture obtained was dispersed in N-methyl-2-pyrrolidone (NMP), and thus a positive electrode mixture paste was produced.

As a current collector, an aluminum foil having a thickness of 12 μm was prepared, the produced positive electrode material mixture paste was applied to one surface of the current collector, was dried at 120° C. for 10 minutes, was thereafter pressurized with a roll press at a linear pressure of 1 t/cm and was then dried in vacuum at 120° C., with the result that a lithium ion secondary battery positive electrode was produced. The produced positive electrode was punched out to a size of 30 mm×40 mm and was used.

The thickness of an electrode material mixture layer in the lithium ion secondary battery positive electrode obtained was 68 μm. The volume filling rate of the electrode active material with respect to the volume of the entire electrode material mixture was 65.9%. A measuring method is described below.

### (Method of Measuring Thickness of Electrode Material Mixture Layer)

In the lithium ion secondary battery positive electrode obtained, the current collector foil and the electrode material mixture layer were integral. The total of the thicknesses was measured with a thickness gauge, and the thickness corresponding to the current collector foil was subtracted, with the result that the thickness of the electrode material mixture layer was determined.

(How to Determine Volume Filling Rate of Electrode Active Material with Respect to Volume of Entire Electrode Material Mixture)

After the production of the lithium ion secondary battery positive electrode, the dry weight (weight per unit area) of the electrode material mixture layer was previously measured, and the density of the electrode material mixture was determined by the thickness of the electrode after being pressed. The occupied volume of each of the components of the electrode material mixture was determined from the weight ratios of the components of the electrode and the true specific gravity (g/cm³), and thus the volume filling rate of the electrode active material with respect to the entire components was calculated. The true specific gravity of the positive electrode active material used in the present example was 4.73 g/cm³.

### [Production of Negative Electrode]

Sodium carboxymethyl cellulose (CMC) serving as a binder and acetylene black serving as a conductive aid were mixed and were dispersed with the planetary mixer, and thus a mixture was obtained. Artificial graphite (AG, D50=12 μm) serving as a negative electrode active material was mixed with the mixture obtained, and was dispersed again with the planetary mixer, and thus a mixture for negative electrode material mixture was obtained. Then, the mixture for negative electrode material mixture obtained was dispersed in N-methyl-2-pyrrolidone (NMP), styrene butadiene rubber (SBR) serving as a binder was added and thus a negative electrode material mixture paste was produced such that the mass ratio was negative electrode active material:conductive aid:styrene butadiene rubber (SBR):binder (CMC)=96.5:1:1.5:1.

As a current collector, an aluminum foil having a thickness of 12 μm was prepared, the produced negative electrode material mixture paste was applied to one surface of the current collector, was dried at 100° C. for 10 minutes, was thereafter pressurized with a roll press at a linear pressure of 1 t/cm and was then dried in vacuum at 100° C., with the result that a lithium ion secondary battery negative electrode was produced. The produced negative electrode was punched out to a size of 34 mm×44 mm and was used.

For the lithium ion secondary battery negative electrode obtained, the thickness of an electrode material mixture layer was determined by the same method as for the positive electrode described above. As a result, the thickness was 77 μm.

### [Production of Lithium Ion Secondary Battery]

As a separator, a nonwoven fabric (thickness of 20 μm) formed with a three-layer laminate of polypropylene/polyethylene/polypropylene was prepared. The positive electrode, the separator and the negative electrode produced as described above were stacked in layers and were inserted into a bag which was obtained by thermally sealing a secondary battery aluminum laminate (made by Dai Nippon Printing Co., Ltd.).

### (Electrolytic Solution)

A solution was obtained by dissolving 1.0 mol/L of LiPF₆ in a solvent in which ethylene carbonate, ethylmethyl carbonate (EMC) and bis(pentafluorophenyl) carbonate were mixed to achieve a volume ratio of 30:67.5:2.5, and the solution obtained was used as an electrolytic solution.

0.128 g (120% by volume with respect to the gap volume) of the electrolytic solution described above was added into the bag which was produced as described above and into which the positive electrode, the separator and the negative electrode were stacked in layers and were inserted, with the result that a lithium ion secondary battery was produced.

For the lithium ion secondary battery electrode obtained, by the following method, the occupancy rate of the cross-sectional area of the high dielectric oxide solid to the cross-sectional area of the total gaps was determined. As a result, the occupancy rate was 11.6%.

### (How to Determine Occupancy Rate of Cross-Sectional Area of High Dielectric Oxide Solid to Cross-Sectional Area of Total Gaps)

(1) For the material mixture layer of the positive electrode or the negative electrode, a cross section of the electrode was cut with an ion milling device, and thus a cross-sectional sample of the electrode material mixture layer was produced.

(2) A field emission scanning electron microscope (FE-SEM) was used to perform shooting with a depopulation voltage of 3 kV, a shooting magnification of 5000 to 10000 times and an image size of 1280×960. A reflected electron image and EDX were used to check the status of the elemental distribution of the cross-sectional sample.

(3) Binarization processing was performed on the reflected electron image of the cross-sectional sample, a graph for a brightness distribution curve was produced, the resulting curve was differentiated to find an inflection point and thus the regions of electrode active material particles and high dielectric oxide solid particles and the remaining region are divided.

(4) Under the division conditions described above, the cross-sectional area occupancy rate of the electrode active material particles, the cross-sectional area occupancy rate of the high dielectric oxide solid particles and the cross-sectional area occupancy rate of the remaining region (the remaining space) were derived.

(5) By performing the operations of (1) to (4) on the total eight places, that is, three places in the up/down direction and five places in the left/right direction of the cross-sectional sample, and the average value of the cross-sectional area occupancy rates of the high dielectric oxide solid particles was assumed to be the occupancy rate of the cross-sectional area of the high dielectric oxide solid to the cross-sectional area of the total gaps. In the calculation of the cross-sectional area occupancy rate, the cross-sectional area occupancy rate A of the electrode active material, the cross-sectional area occupancy rate B of the high dielectric oxide solid particles and the cross-sectional area occupancy rate C of the remaining space which was the remaining region were determined. The occupancy rate of the cross-sectional area of the high dielectric oxide solid to the cross-sectional area of the total gaps was assumed to be a ratio % (B/(B+C)×100) of the cross-sectional area occupancy rate B of the high dielectric oxide solid with respect to the total of the ross-sectional area occupancy rate B of the high dielectric oxide solid and the cross-sectional area occupancy rate C of the remaining space.

### Examples 2 to 3, Comparative Example 2

Lithium ion secondary batteries were produced as in Example 1 except that the composition of the electrolytic solution was changed as shown in table 1.

### Comparative Examples 1, 3

Lithium ion secondary batteries were produced as in Example 1 except that in the positive electrode, the LATP serving as the oxide solid electrolyte was not added and the composition of the electrolytic solution disposed in the gaps formed between the particles of the positive electrode active material was changed as shown in table 1.

### <Evaluations>

The following evaluations were performed on the lithium ion secondary batteries obtained in Examples and Comparative Examples.

### [Initial Discharge Capacity]

The produced lithium ion secondary battery was left to stand at a measurement temperature (25° C.) for 1 hour, was subjected to constant current charge at 0.33C up to 4.2V, was then subjected to constant voltage charge at a voltage of 4.2V for 1 hour, was left to stand for 30 minutes and was discharged at a discharge rate of 0.2C up to 2.5V, with the result that the initial discharge capacity was measured. The results are shown in table 1.

### [Initial Cell Resistance]

The lithium ion secondary battery after the measurement of the initial discharge capacity was adjusted to a charge level (SOC (State of Charge)) of 50%. Then, pulse discharge was performed for 10 seconds with the C rate set to 0.2C, and a voltage when discharge was performed for 10 seconds was measured. Then, with the horizontal axis set to a current value and the vertical axis set to a voltage, a voltage when discharge was performed for 10 seconds with respect to the current at 0.2C was plotted. Then, the lithium ion secondary battery was left to stand for 5 minutes, was thereafter subjected to replenishing charge to return the SOC to 50% t and was then further left to stand for 5 minutes.

Then, the operation described above was performed at each of C rates of 0.5C, 1C, 2C, 5C and 10C, and a voltage when discharge was performed for 10 seconds with respect to the current at each C rate was plotted. Then, the slope of an approximate straight line obtained from the plots was assumed to be the initial cell resistance of the lithium ion secondary battery obtained in the present example. The results are shown in table 1.

[Discharge Capacity after Durability]

As a charge/discharge cycle durability test, an operation of performing constant current charge at 1C up to 4.2V in a constant temperature chamber at 45° C. and then performing constant current discharge at a discharge rate of 2C up to 2.5V was assumed to be one cycle, and the operation was repeated for 500 cycles. After the completion of 500 cycles, the constant temperature chamber was set to 25° C., the lithium ion secondary battery was left to stand for 24 hours in a state after discharge of 2.5V and thereafter as in the measurement of the initial discharge capacity, the discharge capacity after durability was measured. The results are shown in table 1.

[Cell Resistance after Durability]

The lithium ion secondary battery after the measurement of the discharge capacity after durability was subjected to charge so as to be adjusted to an SOC (State of Charge) of 50% as in the measurement of the initial cell resistance, and a cell resistance after durability was measured by the same method as in the measurement of the initial cell resistance. The results are shown in table 1.

### [Cell Resistance Increase Rate]

The cell resistance after durability with respect to the initial cell resistance was determined and was assumed to be a cell resistance increase rate. The results are shown in table 1.

### [Capacity Retention Rate]

The discharge capacity after durability with respect to the initial discharge capacity was determined and was assumed to be a capacity retention rate. The results are shown in table 1.

### [Viscosity]

The viscosity was measured with a rotary viscometer in an environment of 20° C. at a rotation speed of 30 rpm. 0.42

### [Average Molecular Weight of Solvent of Electrolytic Solution]

Based on the following specific gravities, the average molecular weight was calculated from the volume ratio of each solvent.
Ethethylene carbonate (EC): 1.03 g/mL
Dimethyl carbonate (DMC): 1.07 g/mL
Diethyl carbonate (DEC): 0.97 g/mL
Ethylmethyl carbonate (EMC): 1.02 g/mL
Bis(pentafluorophenyl) carbonate: 1.78 g/mL
Tert-butylphenyl carbonate: 1.05 g/mL
Benzyl phenyl carbonate: 1.16 g/mL

### [Flash Point]

The flash point was measured with a tag sealed flash point tester (made by Tanaka Scientific Limited, model: ATG-7) based on JIS K-2265 standards.

TABLE 1

| | | | | Comparative | Comparative | Comparative |
|---|---|---|---|---|---|---|
| | Example 1 | Example 2 | Example 3 | Example 1 | Example 2 | Example 3 |
| A: Cyclic carbonate | EC | EC | EC | EC | EC | EC |
| B: Chain carbonate | EMC | DEC | DEC | DEC | DMC | DMC |
| C: Carbonate having large | Bis(pentafluoro- | tert-Butylphenyl | Benzyl phenyl | Benzyl phenyl | — | — |
| molecular weight | phenyl) carbonate | carbonate | carbonate | carbonate | | |
| A:B:C (Volume ratio) | 30:67.5:2.5 | 30:65:5 | 30:67.5:2.5 | 30:67.5:2.5 | 30:70:0 | 30:70:0 |
| Lithium salt | LiPF₆ | LiPF₆ | LiPF₆ | LiPF₆ | LiPF₆ | LiPF₆ |
| Lithium salt concentration | 1.0 | 1.0 | 1.0 | 1.0 | 1.0 | 1.0 |
| (mol/L) | | | | | | |
| Solid electrolyte | LATP 2 wt % | LATP 2 wt % | LATP 2 wt % | — | LATP 2 wt % | — |
| Average molecular weight | 112 | 113 | 112 | 112 | 89.5 | 89.5 |
| of solvent | | | | | | |
| Flash point | 21° C. | 21° C. | 21° C. | 21° C. | 20° C. | 20° C. |
| | or more | or more | or more | or more | or less | or less |
| Viscosity | 4.2 | 5.9 | 5.3 | 5.3 | 2.1 | 2.1 |
| Initial discharge capacity | 42.1 | 42.3 | 42.0 | 43.3 | 42.3 | 42.9 |
| (mAh) | | | | | | |
| Initial cell resistance (Ω) | 0.82 | 0.81 | 0.75 | 0.91 | 0.78 | 0.79 |
| Discharge capacity after | 34.3 | 34.4 | 34.1 | 34.4 | 34.2 | 34.5 |
| durability (mAh) | | | | | | |
| Cell resistance after | 1.22 | 1.17 | 1.12 | 1.40 | 1.18 | 1.30 |
| durability (Ω) | | | | | | |
| Capacity retention rate (%) | 81.5 | 81.3 | 81.2 | 79.4 | 80.9 | 80.4 |
| Cell resistance increase | 148.8 | 144.4 | 149.9 | 153.8 | 151.3 | 164.6 |
| rate (%) | | | | | | |

### EXPLANATION OF REFERENCE NUMERALS

10 Lithium ion secondary battery
1 Container
2 Positive electrode current collector
3 Positive electrode material mixture layer
4 Positive electrode
5 Negative electrode current collector
6 Negative electrode material mixture layer
7 Negative electrode
8 Separator
9 Electrolytic solution

1. A lithium ion secondary battery electrode comprising an electrode material mixture layer, the electrode mixture layer comprising: an electrode active material; a high dielectric oxide solid; and an electrolytic solution,
wherein in the electrolytic solution, a solvent has an average molecular weight of 110 or more, a flash point of 21° C. or more and a viscosity of 3.0 mPa·s or more.

2. The lithium ion secondary battery electrode according to claim 1, wherein the high dielectric oxide solid and the electrolytic solution are disposed in gaps of the electrode active material.

3. The lithium ion secondary battery electrode according to claim 2, wherein in a cross-sectional observation of the lithium ion secondary battery electrode, a ratio of a cross-sectional area of the high dielectric oxide solid to a cross-sectional area of the total gaps is 1 to 22%.

4. The lithium ion secondary battery electrode according to claim 1, wherein the high dielectric oxide solid is an oxide solid electrolyte.

5. The lithium ion secondary battery electrode according to claim 4, wherein the oxide solid electrolyte is at least one type selected from the group consisting of Li₇La₃Zr₂O₁₂(LLZO), Li_{6.75}La₃Zr_{1.75}Ta_{0.25}O₁₂(LLZTO), Li_{0.33}La_{0.56}TiO₃(LLTO), Li_{1.3}Al_{0.3}Ti_{1.7}(PO₄)₃(LATP) and Li_{1.6}Al_{0.6}Ge_{1.4} (PO₄)₃ (LAGP).

6. The lithium ion secondary battery electrode according to claim 1, wherein a volume filling rate of the electrode active material with respect to a volume of the entire electrode material mixture layer is 60% or more.

7. The lithium ion secondary battery electrode according to claim 1, wherein a thickness of the electrode material mixture layer is 40 μm or more.

8. The lithium ion secondary battery electrode according to claim 1, wherein the lithium ion secondary battery electrode is a positive electrode.

9. The lithium ion secondary battery electrode according to claim 1, wherein the lithium ion secondary battery electrode is a negative electrode.

10. A lithium ion secondary battery comprising: the lithium ion secondary battery electrode according to claim 1; and an electrolytic solution.
